(19) United States
(12) Patent Application Publication
(10) Pub. No.: US 2026/0054275 A1
(43) Pub. Date: Feb. 26, 2026

(54) METHOD AND DEVICE FOR A PRESSURE SWIRL ATOMIZER

(71) Applicant: Collins Engine Nozzles, Inc., Des Moines, IA (US)

(72) Inventors: Jason Ryon, Carlisle, IA (US); Philip Buelow, West Des Moines, IA (US); Andy Tibbs, Earlham, IA (US)

(21) Appl. No.: 18/813,692

(22) Filed: Aug. 23, 2024

(51) Int. Cl. B05B 1/02; B05B 7/10; F23R 3/28

(52) U.S. Cl. CPC B05B 1/02; B05B 7/10; F23R 3/286

(57) ABSTRACT

A pressure swirl atomizer for a gas turbine engine includes atomizer passage walls that define an atomizer passage, a monolithic atomizer tip body abutting the atomizer passage which further includes a first end of the atomizer tip body with a plurality of swirl passages with a plurality of swirl entrances spaced circumferentially around the first end of the atomizer tip body, a central swirl chamber, wherein the plurality of swirl passages extend from the first end of the atomizer tip body to a first end of the central swirl chamber, and a second end of the atomizer tip body with an exit orifice, wherein inner walls of the central swirl chamber taper radially inward from the first end of the central swirl chamber to a second end of the central swirl chamber.

### BACKGROUND

The present disclosure relates to fluid swirlers, and in particular pressure swirl atomizers such as used in fuel injectors for gas turbine engines.

Many devices and methods are used for atomizing liquids, including atomizing liquid fuel for use in combustion engines. Adequately atomized fuel leads to cleaner, more efficient combustion.

Traditional swirl atomizers consist of a spin component and an exit cone. Fuel or another liquid is fed into the spin component at least partially tangentially to the spin components surface, where a film of fuel is created. The fuel then exits the spin component through an exit cone where combustion can occur.

Such systems and methods have been considered satisfactory for their intended purpose. However, the development of more efficient and advanced engines and components drives an ongoing need for improved atomizers.

### SUMMARY

In one example, a pressure swirl atomizer for a gas turbine engine may include atomizer passage walls that define an atomizer passage, a monolithic atomizer tip body abutting the atomizer passage which can further include a first end of the atomizer tip body with a plurality of swirl passages with a plurality of swirl entrances spaced circumferentially around the first end of the atomizer tip body, a central swirl chamber, wherein the plurality of swirl passages extend from the first end of the atomizer tip body to a first end of the central swirl chamber, and a second end of the atomizer tip body with an exit orifice, wherein inner walls of the central swirl chamber taper radially inward from the first end of the central swirl chamber to a second end of the central swirl chamber.

In another example, a method for making a pressure swirl atomizer for a gas turbine engine may include providing a cylindrical body, forming a monolithic atomizer tip body with a central swirl chamber from the cylindrical body, and around a central axis with a lathe, drilling a plurality of swirl passages into a first end of the atomizer tip body, deburring the central swirl chamber, and coining a second end of the atomizer tip body so an inner wall of the central swirl chamber tapers radially inward from the first end of the atomizer tip body to the second end of the atomizer tip body.

### BRIEF DESCRIPTION OF THE DRAWINGS

FIG. 1A is a cross-sectional view of a gas turbine engine pressure swirl atomizer with no tapering of a central swirl chamber.

FIG. 1B is a cross-sectional view of a gas turbine engine pressure swirl atomizer with tapering of a central swirl chamber.

FIG. 2A is a partial phantom view of the gas turbine engine pressure swirl atomizer of FIG. 1A.

FIG. 2B is a partial phantom view of the gas turbine engine pressure swirl atomizer of FIG. 1B.

FIG. 3 is a cross-sectional view of the gas turbine engine pressure swirl atomizer of FIG. 1B mounted in an atomizer passage.

While the above-identified figures set forth embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps and/or components not specifically shown in the drawings.

### DETAILED DESCRIPTION

Up to now, pressure swirl atomizers are generally composed of 2 separate components, a spin component and an exit cone. Due to the pressures typically used, these components are very small. To manufacture a pressure swirl atomizer to the specified performance required is difficult due to machining tolerances on these components, along with geometric stack up of the components. This leads to a need for costly calibration of the assembly, which is typically a manual process. Even if individual components are calibrated separately (spin component and exit cone), there is still some calibration that may be needed after assembly of the two components together. In the current disclosure, a monolithic atomizer tip body 112 eliminates the need to calibrate the spin component and exit cone after assembly, as the atomizer tip body 112 is a single component herein.

This disclosure presents a modified pressure swirl atomizer that may include a monolithic atomizer tip body with a tapered central swirl chamber.

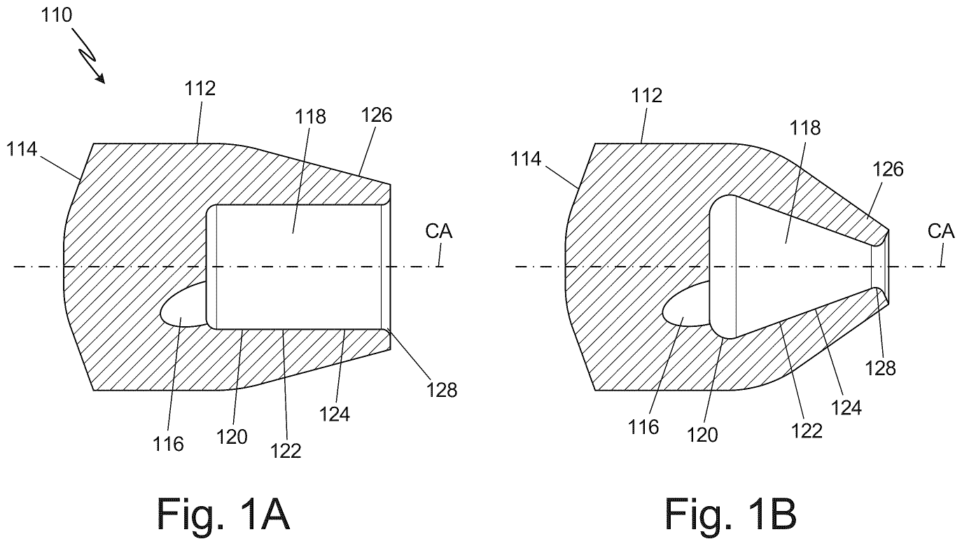

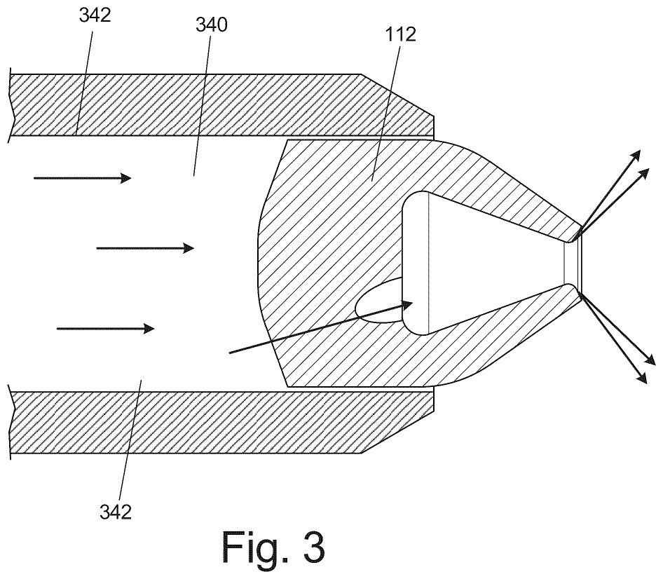

FIG. 1A is a cross-sectional view of a gas turbine engine pressure swirl atomizer with no tapering of a central swirl chamber, which is an intermediate version of the finished pressure swirl atomizer shown in FIG. 1B. FIG. 1B is a cross-sectional view of a gas turbine engine pressure swirl atomizer showing the desired tapering of a central swirl chamber. FIG. 3 is a cross-sectional view of the gas turbine engine pressure swirl atomizer of FIG. 1B mounted in an atomizer passage of a gas turbine engine fuel system. FIG. 1A-B and FIG. 3 will be discussed together.

Pressure swirl atomizer 110 may include monolithic atomizer tip body 112, which can include first end 114 and swirl passages 116. Atomizer tip body 112 can further include central swirl chamber 118 with first end 120, inner walls 122, second end 124 of atomizer tip body 112, exit orifice 126, second end 128 of central swirl chamber 118. Pressure swirl atomizer 110 is configured to be installed in a gas turbine engine. FIG. 3 further includes atomizer passage 340.

As discussed above, pressure swirl atomizer 110 can include atomizer tip body 112. First end 114 of atomizer tip body 112 connects atomizer tip body 112 to swirl passages 116. Swirl passages 116 can flow fluid into central chamber 118. Swirl passages 116 connect to central swirl chamber 118 at first end 120 of central swirl chamber 118. Swirl passages 116 can enter central swirl chamber 118 offset at an acute angle as defined from a central axis CA of the pressure swirl atomizer 110 and the first end 120 of the atomizer body tip 112 to facilitate fluid swirling within central swirl chamber 118. Inner walls 122 of central swirl chamber 118 extend from the first end 120 to the second end 122 of central swirl chamber, and also to second end 124 of atomizer tip body 112. In FIG. 1A, inner walls 122 are formed parallel to a central axis CA of atomizer tip body as an intermediate state, resulting in a larger exit orifice 128 at second end 126 of atomizer tip body 112 then is desired for the finished state of FIG. 1B. In FIG. 1B, inner walls 122 are tapered radially inward as defined by central axis CA, resulting in a smaller exit orifice 128 of the finished state having dimensions selected to provide a preselected pressure drop appropriate for a particular application.

Atomizer passage 340 (shown in FIG. 3), which is defined by atomizer passage walls 342 and is part of a gas turbine engine fuel system, is configured hold atomizer tip body 112 in place and direct a fluid flowing through the atomizer passage 340 to the pressure swirl atomizer 110. An airtight seal between outer walls 113 of the pressure swirl atomizer 110 and atomizer passage walls 342 directs all fluid flows through swirl passages 116. Arrows in FIG. 3 show the flow of fluid from atomizer passage 340, through swirl passages 116, into central swirl chamber 122, and out exit orifice 128 in a cone of fluid.

Inner walls 122 of the central swirl chamber 118 are formed, via coining, to taper radially inward as defined by the central axis CA in FIG. 1B to form the finished pressure swirl atomizer 110. The inner walls 122 can taper at an angle between thirty and sixty degrees or any other desirable angle as defined by a central axis CA in an exemplary embodiment. This tapering via coining allows for an exit cone of fluid to be calibrated into the pressure swirl atomizer 110 without the need for multiple parts such as separate spin components and exit cones as in current pressure swirl atomizers.

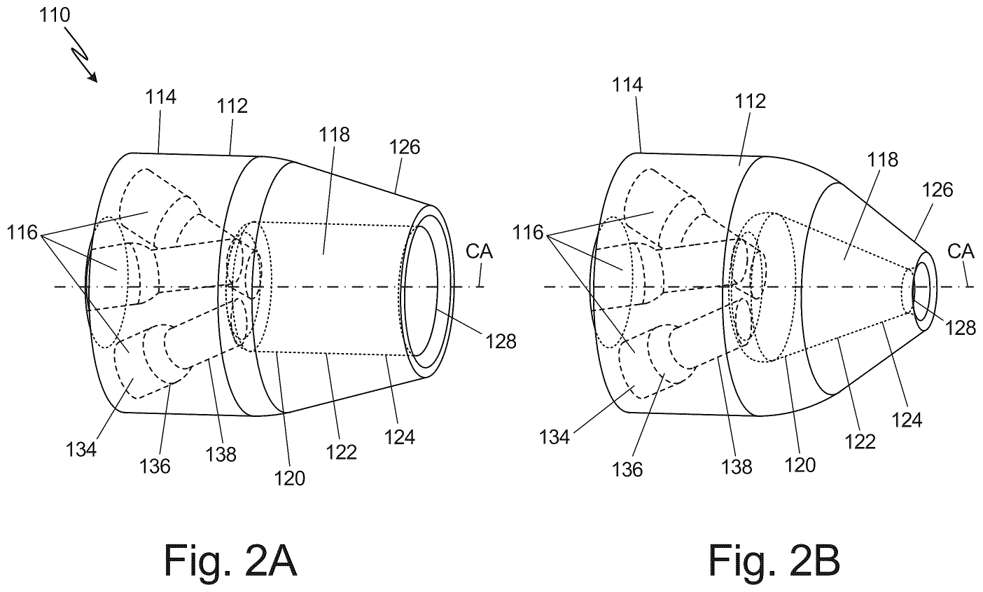

The initial atomizer tip body 112 can be made from a solid cylindrical body of a suitable material, such as a nickel alloy suitable for use in an erosive, high temperature environment. The central swirl chamber 118 can be made by spinning the solid cylindrical body on a lathe. Swirl passages 116 (which will be discussed in detail when discussing FIG. 2A-B) can be drilled into first end 114 of atomizer tip body 112 at an angle. The central swirl chamber 118 can be deburred while inner walls 122 are parallel to central axis CA, greatly reducing the precision needed and any machining imperfections can be cleaned up while the central swirl chamber 118 is accessible. Coining may be used to taper the inner walls radially inward as defined by central axis CA, and narrow exit orifice 128. As known, coining is a cold working process that uses a great deal of force to elastically deform a workpiece, so that it conforms to a die. The die can be used to apply a desired pressure to the exit orifice 128 and create the desired final dimensions for the exit orifice 128. A consistently created pressure swirl atomizer 110 with less variation in the process allows for reduced calibration time, and using fewer piece parts mean less cost. No brazing required on the atomizer tip body components also saves manufacturing time and cost.

The atomizer tip body 112 can be flow checked after swirl passages 116 are drilled (prior to coining) to ensure flow meets performance at this step. Then it is known that the pressure drop allocated specifically to the swirl passages 116 is correct to the design specification. The final pressure drop through the exit orifice 128 is taken at that orifice. The final forming process of the atomizer tip body 112 can be “formed-to-flow. ” The performance of the atomizer tip body 112 (mass flow rates for a given pressure and/or spray cone angle) can be measured in-situ to the process and can be stopped as soon as the specification is achieved without the need for further calibration after forming.

FIG. 2A is a partial phantom view of the gas turbine engine pressure swirl atomizer of FIG. 1A. FIG. 2B is a partial phantom view of the gas turbine engine pressure swirl atomizer of FIG. 1B. FIG. 2A-2B will be discussed together.

Pressure swirl atomizer 110 can include monolithic atomizer tip body 112, which can include first end 114 and swirl passages 116. Atomizer tip body 112 can further include central swirl chamber 118 with first end 120, inner walls 122, second end 124 of atomizer tip body 112, exit orifice 126, second end 128 of central swirl chamber 118. Swirl passages 116 can further include swirl entrances 132, first diameter section 134, taper section 136, and second diameter section 138. Pressure swirl atomizer 110 is configured to be installed in a gas turbine engine.

As discussed above, pressure swirl atomizer 110 can include atomizer tip body 112. First end 114 of atomizer tip body 112 connects atomizer tip body 112 to swirl passages 116. Swirl passages 116 can flow fluid into central swirl chamber 118. Swirl passages 116 connect to central swirl chamber 118 at first end 120 of central swirl chamber 118. Swirl passages 116 can enter central swirl chamber 118 offset at an acute angle as defined from a central axis CA of the pressure swirl atomizer 110 and the first end 120 of the atomizer body tip 112 to facilitate fluid swirling within central swirl chamber 118. Inner walls 122 of central swirl chamber 118 extend from the first end 120 to the second end 122 of central swirl chamber, and also to second end 124 of atomizer tip body 112. In FIG. 1A, inner walls 122 are parallel to a central axis CA of atomizer tip body, resulting in a large exit orifice 128 at second end 126 of atomizer tip body 112. In FIG. 2B, inner walls 122 are tapered radially inward as defined by central axis CA, resulting in a smaller exit orifice 128. Different angles of entry of swirl passages 116 can help facilitate swirling, depending on the desired level of mixing.

Swirl passages 116 enter atomizer tip body 112 at first end 114 of atomizer tip body 114 via swirl entrances 132. In the depicted embodiments, swirl passages 116 can include a first diameter section 134, a taper section 136, and a second diameter section 138. These different diameters of swirl passages 116 help accelerate fluid entering the central swirl chamber 118. It is contemplated that swirl passages 116 can enter central swirl chamber 118 anywhere between first end 120 and second end 124, depending on the desired swirl characteristics.

Different diameters within swirl passages 116 can be made by drilling a first hole with a first diameter from first end 114 of atomizer tip body 112 to first end 120 of central swirl chamber 118, followed by drilling a second hole along the first hole, the second hole drilling having a second diameter larger than the first diameter. The second hole drilled does not extend from first end 114 of atomizer tup body 112 to central swirl chamber 118, but instead stops somewhere between, leaving first diameter section 134 and second diameter section 138. Taper section 136 can be made with a different drill bit or other process known to those in the art to taper between first diameter section 134 and second diameter section 138. Different diameters of swirl passages 116 help create faster fluid entering central swirl chamber 118, resulting in more mixing and swirling.

During drilling of swirl passages 116, it is also contemplated that flowing fluid through swirl passages 116 prior to coining (discussed above with regards to FIG. 1A-B but equally applicable here) and measuring pressure drop through swirl passages 116 prior to coining. This allows calibration of the swirl passages 116 of the monolithic atomizer tip body prior to coining central swirl chamber 118 and making it difficult to individually measure swirl passage 116 performance outside of exit orifice 128.

As discussed above, the pressure swirl atomizer 110 of this disclosure exhibits less variation in the manufacturing process that allows for reduced calibration time. Forming the pressure swirl atomizer 110 with fewer piece parts reduces the cost of manufacturing. Forming the atomizer tip components by coining rather than brazing results in a monolithic pressure swirl atomizer 110 that reduces part count, manufacturing time, and cost.

### Discussion of Possible Embodiments

The following are non-exclusive descriptions of possible embodiments of the present invention.

A pressure swirl atomizer for a gas turbine engine can include atomizer passage walls that define an atomizer passage, a monolithic atomizer tip body abutting the atomizer passage which further includes a first end of the atomizer tip body with a plurality of swirl passages with a plurality of swirl entrances spaced circumferentially around the first end of the atomizer tip body, a central swirl chamber, wherein the plurality of swirl passages extend from the first end of the atomizer tip body to a first end of the central swirl chamber, and a second end of the atomizer tip body with an exit orifice, wherein inner walls of the central swirl chamber taper radially inward from the first end of the central swirl chamber to a second end of the central swirl chamber.

The pressure swirl atomizer of the preceding paragraph can optionally include, additionally and/or alternatively, any one or more of the following features, configurations and/or additional components:

The plurality of swirl passages of the pressure swirl atomizer can be offset at an acute angle as defined from a central axis of the pressure swirl atomizer and the first end of the atomizer body tip.

The plurality of swirl passages can beconfigured to direct fluid flow at a predetermined angle into the central swirl chamber.

The plurality of swirl passages can further include a first diameter section, a tapered section, and a second diameter section.

The first diameter section of the preceding paragraph can have a cross-sectional area larger than the second diameter section cross-sectional area.

The second diameter section can connected to the first diameter section via the tapered section, the second diameter section connects to the central swirl chamber at a first angle defined by a central axis of the pressure swirl atomizer, and the first diameter section connects to the first end of the atomizer tip body at a second angle defined by the central axis of the pressure swirl atomizer.

The pressure swirl atomizer can have inner walls of the central swirl chamber tapered inward via coining.

The inner walls of the central swirl chamber can taper at an angle between 30 and 60 degrees as defined by a central axis.

Exits of the plurality of swirl passages can have larger cross-sectional areas than the exit orifice.

The atomizer tip body and the atomizer passage can be made from a high-temperature resistant material composed of, nickel alloy, Greek ascoloy, or stainless steel.

In another example, a method for making a pressure swirl atomizer for a gas turbine engine can include providing a cylindrical body, forming a monolithic atomizer tip body with a central swirl chamber from the cylindrical body, and around a central axis with a lathe, drilling a plurality of swirl passages into a first end of the atomizer tip body, deburring the central swirl chamber, and coining a second end of the atomizer tip body so an inner wall of the central swirl chamber tapers radially inward from the first end of the atomizer tip body to the second end of the atomizer tip body.

The method of the preceding paragraph can optionally include, additionally and/or alternatively, any one or more of the following features, configurations and/or additional components:
Drilling the plurality of swirl passages can further include drilling a first hole with a first diameter from the first end of the atomizer tip body to a first end of the central swirl chamber;
drilling a second hole along the first hole, the second hole drilling having a second diameter larger than the first diameter.

Drilling the plurality of swirl passages can further include flowing fluid through the plurality of swirl passages prior to coining, and measuring pressure drop through the plurality of swirl passages prior to coining.

The method can further include measuring performance of the atomizer tip body at a given pressure after coining.

The method can further include mounting the atomizer tip body within an atomizer passage.

Drilling the plurality of swirl passages can further include offsetting the swirl passages at an acute angle as defined from a central axis of the pressure swirl atomizer and the first end of the atomizer body tip.

The plurality of swirl passages can direct fluid flow at a predetermined angle into the central swirl chamber.

Coining the second end of the atomizer tip body can further include coining so the inner walls of the central swirl chamber taper at an angle between 30 and 60 degrees as defined by a central axis.

The method can include plurality of swirl passages that have larger cross-sectional areas than the exit orifice after coining.

The method can further include drilling the second hold creating a tapered section.

The atomizer tip body and the atomizer passage created in the method can comprise a high-temperature resistant material composed of, nickel alloy, Greek ascoloy, or stainless steel.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A pressure swirl atomizer for a gas turbine engine, comprising:
atomizer passage walls that define an atomizer passage;
a monolithic atomizer tip body abutting the atomizer passage, further comprising:
a first end of the atomizer tip body with a plurality of swirl passages with a plurality of swirl entrances spaced circumferentially around the first end of the atomizer tip body;
a central swirl chamber, wherein the plurality of swirl passages extend from the first end of the atomizer tip body to a first end of the central swirl chamber; and
a second end of the atomizer tip body with an exit orifice, wherein inner walls of the central swirl chamber taper radially inward from the first end of the central swirl chamber to a second end of the central swirl chamber.

2. The pressure swirl atomizer of claim 1, wherein the plurality of swirl passages are offset at an acute angle as defined from a central axis of the pressure swirl atomizer and the first end of the atomizer body tip.

3. The pressure swirl atomizer of claim 1, wherein the plurality of swirl passages are configured to direct fluid flow at a predetermined angle into the central swirl chamber.

4. The pressure swirl atomizer of claim 1, wherein the plurality of swirl passages further comprises a first diameter section, a tapered section, and a second diameter section.

5. The pressure swirl atomizer of claim 4, wherein the first diameter section has a cross-sectional area larger than the second diameter section cross-sectional area.

6. The pressure swirl atomizer of claim 5, wherein the second diameter section is connected to the first diameter section via the tapered section, the second diameter section connects to the central swirl chamber at a first angle defined by a central axis of the pressure swirl atomizer, and the first diameter section connects to the first end of the atomizer tip body at a second angle defined by the central axis of the pressure swirl atomizer.

7. The pressure swirl atomizer of claim 1, wherein the inner walls of the central swirl chamber are tapered inward via coining.

8. The pressure swirl atomizer of claim 7, wherein the inner walls of the central swirl chamber taper at an angle between 30 and 60 degrees as defined by a central axis.

9. The pressure swirl atomizer of claim 1, wherein the atomizer tip body and the atomizer passage comprise a high-temperature resistant material composed of, nickel alloy, Greek ascoloy, or stainless steel.

10. A method comprising:
providing a cylindrical body;
forming a monolithic atomizer tip body with a central swirl chamber from the cylindrical body, and around a central axis with a lathe;
drilling a plurality of swirl passages into a first end of the atomizer tip body;
deburring the central swirl chamber; and
coining a second end of the atomizer tip body so an inner wall of the central swirl chamber tapers radially inward from the first end of the atomizer tip body to the second end of the atomizer tip body.

11. The method of claim 10, wherein drilling the plurality of swirl passages further comprises:
drilling a first hole with a first diameter from the first end of the atomizer tip body to a first end of the central swirl chamber;
drilling a second hole along the first hole, the second hole drilling having a second diameter larger than the first diameter.

12. The method of claim 11, wherein drilling the plurality of swirl passages further comprises:
flowing fluid through the plurality of swirl passages prior to coining; and
measuring pressure drop through the plurality of swirl passages prior to coining.

13. The method of claim 12, further comprising:
measuring performance of the atomizer tip body at a given pressure after coining.

14. The method of claim 13, further comprising:
mounting the atomizer tip body within an atomizer passage.

15. The method of claim 10, wherein drilling the plurality of swirl passages further comprises:
offsetting the swirl passages at an acute angle as defined from a central axis of the pressure swirl atomizer and the first end of the atomizer body tip.

16. The method of claim 10, wherein the plurality of swirl passages are configured to direct fluid flow at a predetermined angle into the central swirl chamber.

17. The method of claim 10, wherein coining the second end of the atomizer tip body further includes coining so the inner walls of the central swirl chamber taper at an angle between 30 and 60 degrees as defined by a central axis.

18. The method of claim 10, wherein exits of the plurality of swirl passages have larger cross-sectional areas than the exit orifice after coining.

19. The method of claim 11, wherein drilling the second hold includes creating a tapered section.

20. The method of claim 11, wherein the atomizer tip body and the atomizer passage comprise a high-temperature resistant material composed of, nickel alloy, Greek ascoloy, or stainless steel.
